(19) United States
(12) Patent Application Publication
(10) Pub. No.: US 2019/0293299 A1
(43) Pub. Date: Sep. 26, 2019

(54) Grill

(71) Applicant: ACCENTE LIMITED, Wong Tai Sin (HK)

(72) Inventor: Rason Lee, KOWLOON CITY (HK)

(73) Assignee: ACCENTE LIMITED, Wong Tai Sin (HK)

(21) Appl. No.: 16/031,070

(22) Filed: Jul. 10, 2018

(30) Foreign Application Priority Data
Mar. 22, 2018 (DE) 20 2018 101 593.1

(51) Int. Cl. F24C 15/00; F24C 1/04; A47J 37/06

(52) U.S. Cl. CPC F24C 15/006; A47J 37/06; F24C 1/04

(57) ABSTRACT

A grill has a housing and at least one grilling chamber provided inside of an inner receptacle of the housing. At least one combustion chamber is arranged within the housing and above the receptacle. An air supply is provided. The air supply comprises a plurality of air inlets provided in the lower region of the housing and air outlets located in the upper region of the housing, wherein the inner receptacle with its side walls is spaced apart from the inner wall of the housing such that an air flow directed from below the grilling chamber into the combustion chamber is produced. The air flow flows past outside on the inner receptacle upwards in the direction of the combustion chamber.

### TECHNICAL FIELD

### The present disclosure relates to a grill.

### BACKGROUND

Grills are known from the state of the art, which are equipped with a housing and at least one grilling chamber provided inside an inner receptacle of the housing, with at least one combustion chamber arranged inside the housing above the receptacle, and with an air supply.

Gas grill devices having a combustion system are further known from the prior art, which reach an extremely high temperature of up to or above 800° C. and thus offer a faster cooking performance. The extremely high temperature leads to a caramelization of the surface of the grilled food within a very short time. Gas grills are also known which generate a top heat and thus protect the grilled food from dripping grease. The taste of the grilled food is optimized by the extreme heat and the fast caramelization process. No flame may arise from dripping fat and thus adulterate the taste.

The problem with these grills is that they become extremely hot outside on the housing and thus represent a source of danger for burns.

### SUMMARY

The present disclosure is based on the object of providing a grill that eliminates the aforementioned problems.

This object is accomplished by a grill having a housing and at least one grilling chamber provided inside of an inner receptacle of the housing. At least one combustion chamber is arranged within the housing and above the receptacle. An air supply is provided. The air supply comprises a plurality of air inlets provided in the lower region of the housing and air outlets located in the upper region of the housing, wherein the inner receptacle with its side walls is spaced apart from the inner wall of the housing such that an air flow directed from below the grilling chamber into the combustion chamber is produced. The air flow flows past outside on the inner receptacle upwards in the direction of the combustion chamber.

The present problem is thus solved in that holes introduced on the outer housing and the air circulation influenced thereby effect a secondary combustion system. Oxygen is sucked up by the outflowing air below and thus the burner is fed with additional oxygen. As a result, the outer housing no longer becomes as hot as with known models.

### BRIEF DESCRIPTION OF THE DRAWINGS

Other objects, features, advantages and applications of the grill according to the invention will become apparent from the following description of an embodiment with reference to the drawings.

FIG. 1 shows a grill in a front view, partially broken open.

FIG. 2 shows the grill in a side view, partially broken open.

FIG. 3 shows the grill in the rear view, partially broken open.

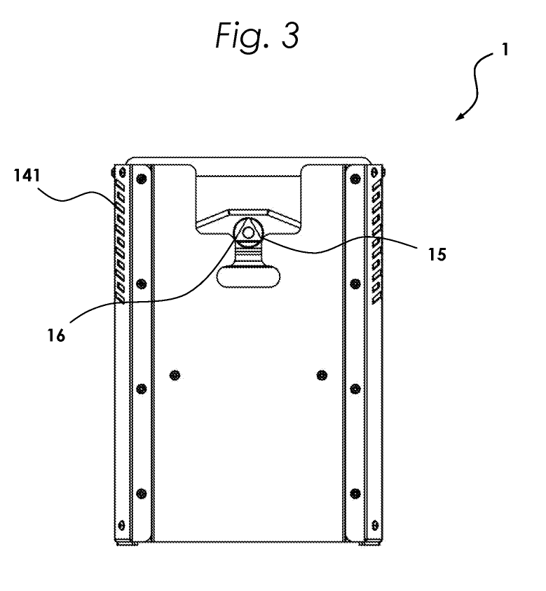

### DETAILED DESCRIPTION

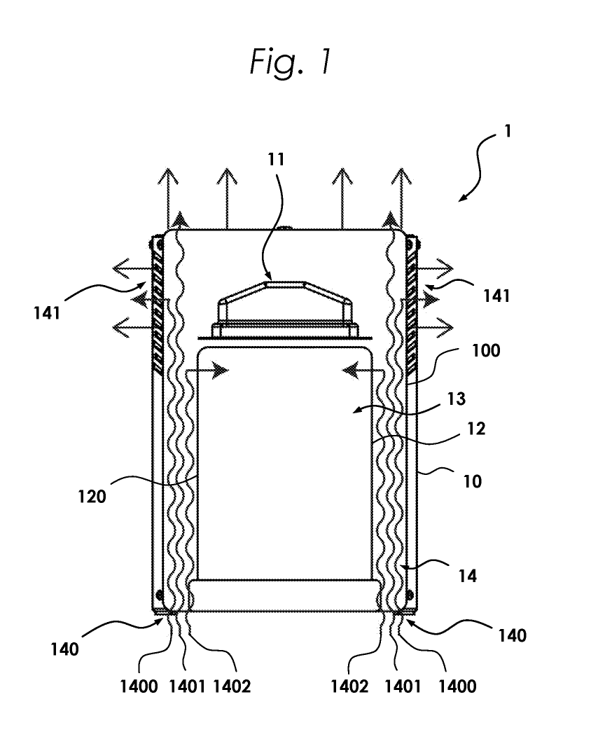

As shown in FIG. 1, the grill 1 includes a housing 10 and at least one grilling chamber 13 provided within an inner receptacle 12 of the housing 10. At least one combustion chamber 11 is arranged within the housing 10 and above the receptacle 12. The grill further includes an air supply 14.

The air supply 14 advantageously includes air inlets 140 provided on both sides of the housing 10 and in its lower region, and air outlets 141 located in an upper region of the housing 10.

The inner receptacle 12 with its side walls 120 is spaced apart from an inner wall 100 of the housing 10 such that an air flow 1400, 1401, 1402 directed from below the grilling chamber 13 into the combustion chamber 11 is produced. The air flow preferably flows past both sides (FIG. 1) of the inner receptacle 12 upwards in the direction of the combustion chamber 11.

Referring to FIG. 1, the disclosed grill allows the outer housing 10 to have a cooler surface and also enables a secondary combustion, when the upward moving (heated) air 1402 flows in from below after heating up through the air inlets 1200 upward in the side walls and into the receptacle 12 for the secondary combustion. The heated air 1400, 1401 is released together with the heat produced through the housing 10 during use, the combustion becomes more complete and less carbon monoxide is released and thus a higher temperature is achieved in the combustion chamber.

In a particularly advantageous embodiment, air outlets 141 are provided, at which the air 1400, 1401 passes outward on the housing 10, wherein preferably each side comprises a similar number of air outlets 141.

The primary air coming from the burner tube 1403 enters into the combustion chamber 11 and mixes with the gas located there. Most of the heat 1404, 1405 that is produced flows outwardly from the front side of the receptacle 12 after the combustion.

The combustion chamber 11 advantageously comprises at least one radiant heater, which is arranged on its upper side and emits heat into the grilling chamber 13, wherein at least a part of the radiant heater is designed as an injection system in which at least one air inlet leads to the stabilization of the amounts of oxygen which are introduced into the combustion chamber 11.

Furthermore, it is advantageously provided that additional air inlets 140 are provided, which support the combustion by additionally providing the combustion process with oxygen and simultaneously allowing the hot air to escape.

At least one air passage opening between the grilling chamber 12 and the combustion chamber 11 is preferably provided in the outer housing 10, which is designed such that the hot air can escape better and so the outer housing 10 is heated less.

The air inlets 140 are preferably arranged in the outer housing 10 such that there is inflowing oxygen for supporting a secondary combustion, which significantly reduces the carbon monoxide emission during grilling.

Moreover, in a further advantageous embodiment of the invention, air outlets 142 are provided, by means of which more air enters the combustion chamber 11, wherein primary air 1500 enters or exits through at least one air passage opening 150 up the burner tube.

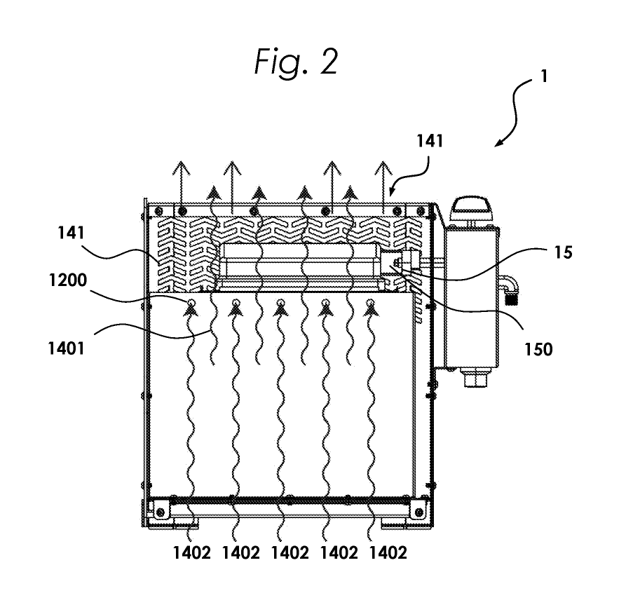

As shown in FIG. 2, preferably air 1600 passes to air passage openings 160 on an advantageously provided stabilizer 16 or air passage openings between the tube wall and the stabilizer 16 as primary air to the burner.

The grill 1 according to the invention is not limited in its execution to the above-mentioned preferred embodiments. Rather, a variety of design variations are conceivable, which make use of the illustrated solution even with fundamentally different type of execution.

### LIST OF REFERENCE NUMBERS

1 grill
10 housing
11 combustion chamber
12 receptacle
13 grill
14 air supply device
15 burner tube
16 stabilizer
100 inner wall of the housing
110 radiant heater
120 side walls of the receptacle
140 air inlets
141 air outlets
1200 air inlets in the side walls
1400, 1401 air flow
1402 air flow for secondary combustion
150 air passage opening on the burner tube
160 air passage openings on the stabilizer
1500 air flow through air passage opening on the burner tube
1600 air flow on the stabilizer

What is claimed is:

1. A grill, comprising:
a housing;
at least one grilling chamber provided inside of an inner receptacle of the housing;
at least one combustion chamber arranged within the housing above the receptacle; and
an air supply having a plurality of air inlets located in a lower region of the housing and air outlets located in an upper region of the housing,
wherein the inner receptacle has side walls which are spaced apart from an inner wall of the housing such that an air flow directed from below the grilling chamber into the combustion chamber is produced, the air flow flowing past an outside of the inner receptacle upwards towards the combustion chamber.

2. The grill according to claim 1,
wherein the combustion chamber comprises at least one radiant heater which is arranged on its upper side and emits heat into the grilling chamber, and
wherein at least a part of the radiant heater is designed as an injection system, with which at least one air inlet leads to a stabilization of amounts of oxygen that are introduced into the combustion chamber.

3. The grill according to claim 1,
wherein additional air inlets are provided, which support the combustion by additionally providing the combustion process with oxygen and at the same time allow hot air to escape.

4. The grill according to claim 1,
wherein at least one air passage opening is provided between the grilling chamber and the combustion chamber in the housing, whereby hot air is able to escape and thereby the housing is heated less.

5. The grill according to claim 1,
wherein the air inlets in the housing are arranged such that there is inflowing oxygen for supporting a secondary combustion, which significantly reduces the carbon monoxide emission during grilling.

6. The grill according to claim 1,
wherein the air outlets are arranged such that more air enters the combustion chamber, and
wherein primary air exits through at least one air passage opening in a burner tube.
